(19) United States
(12) Patent Application Publication
(10) Pub. No.: US 2002/0092592 A1
(43) Pub. Date: Jul. 18, 2002

(54) Recovering device for vehicle-consumed power

(76) Inventor: George F. Huang, Taipei (TW)

Correspondence Address: Dougherty & Troxell, Suite 1404, 5205 LEESBURG PIKE, FALLS CHURCH, VA, 22041, US

(21) Appl. No.: 09/760,887

(22) Filed: Jan. 17, 2001

(51) Int. Cl. B60C 23/10

(52) U.S. Cl. 152/419

(57) ABSTRACT

Recovering device for vehicle-consumed power, including an inflating pump unit fixed on a rim. A circumference of the inflating pump unit is formed with multiple inflating holes. Links are connected in the inflating holes, whereby the links are radially arranged on the circumference of the inflating pump unit. One end of each link is connected with an inner face of the tire. A center of the inflating pump unit is connected with an air conduit for outputting compressed air produced by the inflating pump unit. Multiple extensible connecting tubes are disposed between the inner face of the tire and the rim. Each extensible connecting tube is formed with a central hole in which the link is fitted. When the tire rolls over the ground, due to the vehicle's own weight, the tire is repeatedly compressed to make the links continuously inflate the inflating pump unit which produces and outputs compressed air via the air conduit. The compressed air serves to generate power during running of the vehicle.

### BACKGROUND OF THE INVENTION

The present invention is related to a recovering device for vehicle-consumed power, and more particularly to a power-recovering device which is able to recover consumed power during running of the vehicle and utilize the recovered power to generate electricity or provide energy for the vehicle. Therefore, the energy is save and the travel of the vehicle can be prolonged.

It is a trend to manufacture vehicles free from the problem of environmental pollution. Accordingly, electrically powered cars have been developed to fulfill the requirement of environmental protection. However, the greatest obstacle to the development of the existent electric car is that the battery can only provide such a power that the electric car can only run by a short travel. Moreover, it costs much time to recharge the battery and the battery is too heavy. Also, the cost for the electric car is relatively high. In addition, the charging stations can be hardly popularly built so that it is inconvenient in driving electric car. As a result, up to now, the electric cars cannot be mass-produced and widely used. Furthermore, only a little part of the power supplied by the battery is used to drive the car, while most of the power is consumed by the frictional force between the tire and ground, air resistance, car weight, etc. Therefore, the power utilization efficiency can be hardly promoted.

### SUMMARY OF THE INVENTION

It is therefore a primary object of the present invention to provide a recovering device for vehicle-consumed power, which is able to recover the power consumed when the tire acts on the ground during running of the vehicle. The recovered power is conducted to a generator or other appliance to generate electricity or provide energy for driving the vehicle. Therefore, the energy is save and the power utilization efficiency is promoted. Also, the requirement of environmental protection can be fulfilled.

According to the above object, the recovering device for vehicle-consumed power of the present invention includes an inflating pump unit fixed on a rim. A circumference of the inflating plump unit is formed with multiple inflating holes. Links are connected in the inflating holes, whereby the links are radially multi-layer arranged on the circumference of the inflating pump unit. One end of each link is connected with an inner face of the tire. A center of the inflating pump unit is connected with an air conduit for outputting compressed air produced by the inflating pump unit. Multiple extensible connecting tubes are disposed between the inner face of the tire and the rim. Each extensible connecting tube is formed with a central hole in which the link is fitted. When the tire rolls over the ground, due to the vehicle's own weight, the tire is repeatedly compressed to make the links continuously inflate the inflating pump unit which produces and outputs compressed air via the air conduit. The compressed air serves to generate power during running of the vehicle.

The present invention can be best understood through the following description and accompanying drawings wherein:

### BRIEF DESCRIPTION OF THE DRAWINGS

FIG. 1 is a side sectional view of the structure of the present invention;

FIG. 2 is a front sectional view of the structure of the present invention:

FIG. 3 is a side sectional view of the structure of another embodiment of the present invention;

FIG. 4 is an enlarged view of the rack and ratchet of the other embodiment of the present invention; and

FIG. 5 is an enlarged sectional view of the pump and the sleeve of the other embodiment of the present invention.

### DETAILED DESCRIPTION OF THE PREFERRED EMBODIMENTS

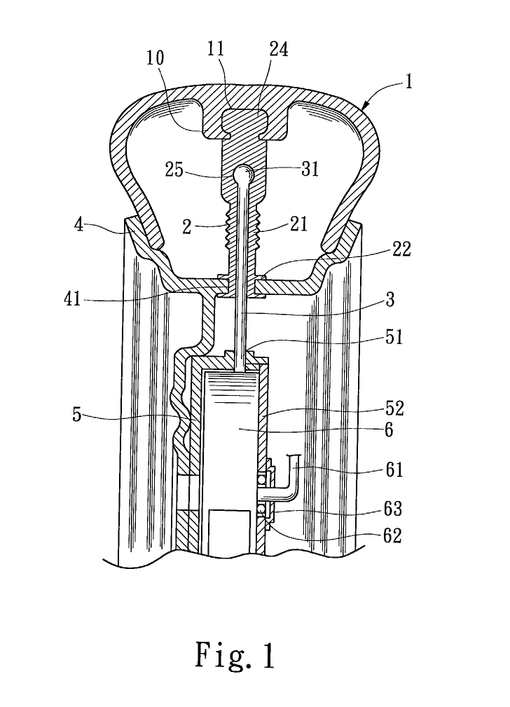

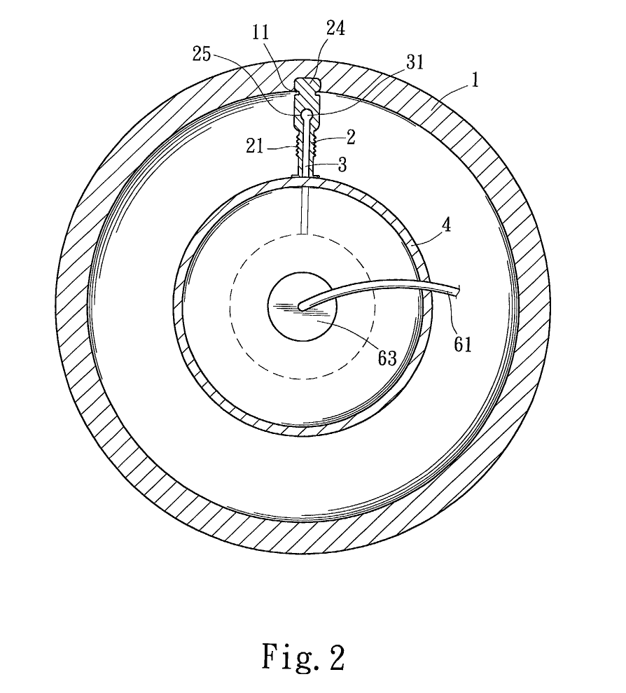

Please refer to FIGS. 1 and 2. The recovering device for vehicle-consumed power of the present invention includes a tire 1, multiple extensible connecting tubes 2, multiple links 3, a rim 4, a seat body 5 and an inflating pump unit 6. When manufacturing the tire 1, the inner face thereof Is directly integrally formed with one or more annular continuous ribs 10. The ribs 10 define therebetween multiple channels 11 at equal intervals. Each channel 11 has a narrower opening and wider interior. In a preferred embodiment, the extensible connecting tube 2 is made of rubber material and formed with a central blind hole at one end. The inner end of the central hole is formed with an enlarged cavity 25 having an inner diameter larger than the inner diameter of the central hole. The other end of the extensible connecting tube 2 is formed with an engaging head 24. A certain portion of the extensible connecting tube 2 is formed with crimped extensible section 21. The open end of the extensible connecting tube 2 is formed with an upper flange 22 and a lower flange 23. The engaging head 24 has a shape corresponding to the channel 11. The link 3 has a head section 31 at one end with a shape corresponding to the cavity 25 of the extensible connecting tube 2. The circumference of the inflating pump unit 6 is formed with multiple inflating holes. The other end of the link 3 is sealedly fitted in the inflating hole, whereby the links 3 are radially arranged on the circumference of the inflating pump unit 6. The center of the inflating pump 6 is connected with an air conduit 61 for outputting compressed air produced by the inflating pump 6.

The seat body 5 is formed with an interior space and fixed on inner side of the rim 4. The circumference of the rim 4 is formed with multiple perforations 41. The circumference of the seat body 5 is formed with multiple through holes 51 corresponding to the perforations 41. The inflating pump unit 6 is fixedly mounted in the seat body 5. Each extensible connecting tube 2 is passed through the perforation 41 of the rim 4 with the upper and lower flanges 22, 23 clamping and engaging with two side edges of the perforation 41. Each link 3 connected with the inflating pump unit 6 is passed through the through hole 51 of the seat body 5 and the extensible connecting tube 2 with the head section 31 engaged in the cavity 25 of the extensible connecting tube 2. The engaging head 24 of the extensible connecting tube 2 is fitted in the channel 11 of the tire 1. A cover board 52 is disposed on the seat body 5. A bearing 62 is disposed at the center of the cover board 52. The air conduit 61 is fitted in the bearing 62 and extends out to connect with a generator or other appliance. The cover board 52 serves to cover the seat body 5 to shield the inflating pump unit 6. When the tire 1 revolves, the air conduit 61 fitted in the bearing 62 is prevented from rotating along with the tire 1. An outer cover 63 is disposed at the center of outer side of the cover board 52. The outer cover 63 is formed with a central hole through which the air conduit extends out.

According to the above arrangement, when the tire 1 rolls over the ground, due to the vehicle's own weight, the ground-contacting face of the tire 1 is compressed. As a result, the links 3 will be axially moved toward the inflating pump unit 6 to send external air thereinto. A one-way valve is disposed in the inflating pump unit 6 for preventing the air from reversely flowing out of the inflating pump unit 6. The extensible connecting tube 2 along with the axially moving link 3 is extended. The cavity 25 of the extensible connecting tube 2 and the head section 31 of the link 3 cooperatively serve as a joint, whereby the multi-directional action force exerted by the tire 1 rolling over the ground will not damage the link 3. During continuous revolution of the tire 1, the links 3 will inflate the Inflating pump unit 6 by turns. As a result, the compressed air is continuously output from the air conduit 61 and conducted into the generator for generating electricity. Alternatively, the compressed air can be conducted into other appliance which can work by means of the compressed air.

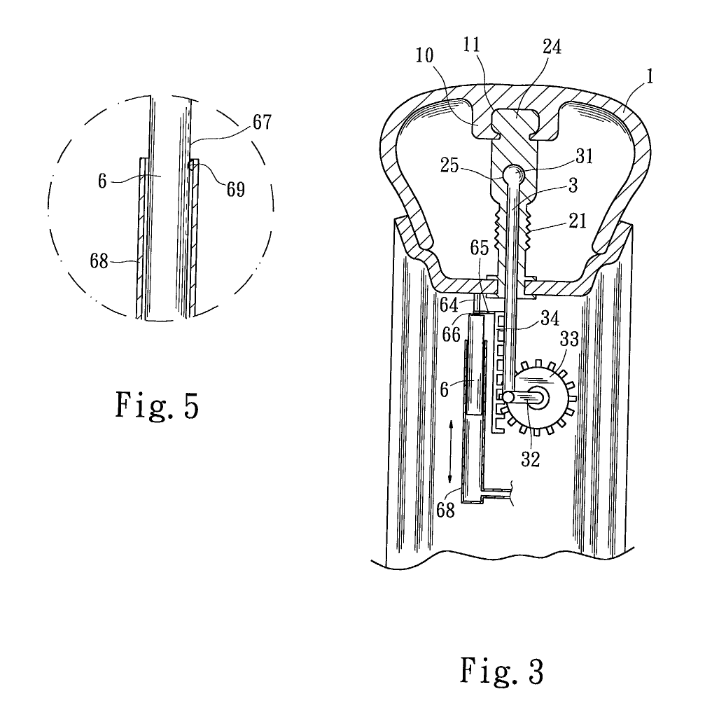

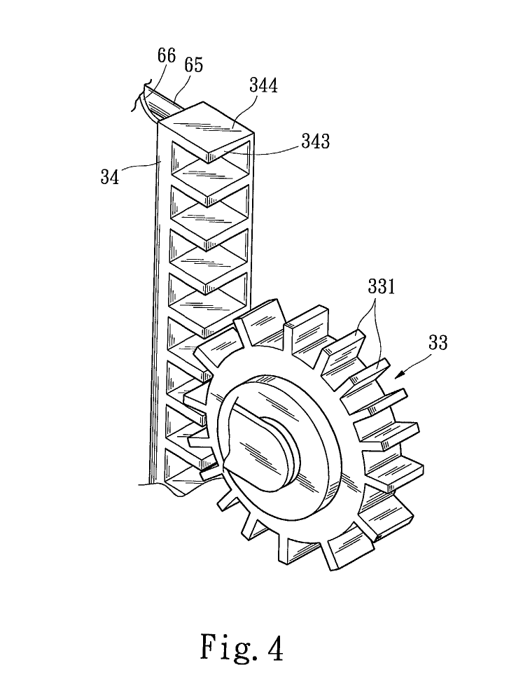

FIGS. 3 and 4 show another embodiment of the present invent ion. One end of the link 3 via a crank 32 is coupled with a one-way ratchet 33 having multiple teeth 331 arranged on the circumference. The ratchet 33 meshes with a rack 34 positioned in the rotational path of the ratchet 33. The rack 34 has multiple tooth blocks 341 having a close lateral side. At least one tooth block at rear end of the rack 34 is open. A top tooth block 343 of the rack 34 has a slope face 344 inclined toward the close side. The inflating pump unit 6 is positioned beside the rack 34. A post 64 is disposed at an end section of the inflating pump unit 6. One end of a connecting member 65 is fitted on the post 64. The other end of the connecting member 65 is connected with the rack 34. One end of a resilient member 66 is connected with the inflating pump unit 6. The resilient member 66 is fitted on the post 64 with the other end connected with the rack 34. One side of the pump 6 is formed with locating notches 67. The pump 6 is axially movably fitted in a sleeve 68 formed with an inward extending flange 69 corresponding to the locating notches 67.

According to the above arrangement, when the tire 1 revolves, the links 3 continuously drive the ratchet 33 to gradually mesh with and move down the rack 34. Simultaneously, the pump 6 is driven to move downward. When the ratchet 33 meshes with the top tooth block 343 of the rack 34 and contacts with the slope face 344 thereof, the rack 34 slips away and disengages from the ratchet 33. Then the pump 6 and the rack 34 are subject to a pressure and restore to their home positions. At the same time, the resilient member 66 exerts a resilient restoring force onto the rack 34, whereby the bottom tooth block 341 of the rack 34 is again engaged with the ratchet 33. Such operation is repeated to output compressed air with greater power. Therefore, the energy can be recovered.

The above embodiments are only used to illustrate the present invention, not intended to limit the scope thereof. Many modifications of the above embodiments can be made without departing from the spirit of the present invention.

What is claimed is:

1. Recovering device for vehicle-consumed power, comprising:
an inflating pump unit fixed on a rim, a circumference of the inflating pump unit being formed with multiple inflating holes, links being connected in the inflating holes, whereby the links are radially multi-layer arranged on the circumference of the inflating pump unit, a center of the inflating pump unit being connected with an air conduit for outputting compressed air produced by the inflating pump unit;
a tire having an inner face formed with multiple channels; and
multiple extensible connecting tubes disposed between the channels of the tire and the rim, one end of each extensible connecting tube being fixed on the rim and formed with a central hole in which the link is fitted, whereby when the tire rolls over the ground, due to the vehicle's own weight, the tire is repeatedly compressed to make the links continuously inflate the inflating pump unit which produces and outputs compressed air via the air conduit.

2. Recovering device for vehicle-consumed power as claimed in claim 1, wherein each channel formed on inner face of the tire has a narrower opening and a wider interior.

3. Recovering device for vehicle-consumed power as claimed in claim 1, wherein the extensible connecting tube is made of rubber material.

4. Recovering device for vehicle-consumed power as claimed in claim 1 wherein a certain portion of the extensible connecting tube is formed with a crimped extensible section.

5. Recovering device for vehicle-consumed power as claimed in claim 2, wherein a certain portion of the extensible connecting tube is formed with a crimped extensible section.

6. Recovering device for vehicle-consumed power as claimed in claim 1, wherein a certain portion of the extensible connecting tube is formed with an upper flange and a corresponding lower flange, a circumference of the rim being formed with multiple perforations, the extensible connecting tubes being passed through the perforation with the upper and lower flanges clamping and engaging with two side edges of the perforations so as to fix the extensible connecting tubes on the rim.

7. Recovering device for vehicle-consumed power as claimed in claim 1, wherein an inner end of the central hole of the extensible connecting tube is formed with an enlarged cavity corresponding to a head section of the link, whereby the head section is freely rotatably fitted in the cavity to connect the link with the extensible connecting tube.

8. Recovering device for vehicle-consumed power as claimed in claim 1, wherein one end of the extensible connecting tube is formed with an engaging head having a shape corresponding to the channel of the tire, whereby the engaging head is freely rotatably fitted in the channel to connect the extensible connecting tube with the tire.

9. Recovering device for vehicle-consumed power as claimed in claim 1, further comprising a ratchet meshing with a rack positioned in the rotational path of the ratchet, the rack having multiple tooth blocks in which a top tooth block of the rack has a slope face.

10. Recovering device for vehicle-consumed power as claimed in claim 9, wherein a sleeve is disposed beside the rack and communicated with the inflating hole of the inflating pump unit, a pump being fitted in the sleeve, a post being disposed at an end section of the pump, one end of a connecting member being fitted on the post, the other end of the connecting member being connected with the rack, one end of a resilient member being connected with the pump, the resilient member being fitted on the post with the other end connected with the rack.

11. Recovering device for vehicle-consumed power as claimed in claim 9, wherein one side of the pump is axially movably fitted in the sleeve and formed with locating notches, an inner side of the sleeve being formed with an inward extending flange corresponding to the locating notches.
